(19) United States
(12) Patent Application Publication
(10) Pub. No.: US 2009/0159366 A1
(43) Pub. Date: Jun. 25, 2009

(54) PERSONNEL FALL ARREST SYSTEM

(75) Inventors: David Alexander, Mokena, IL (US); John Langford, Fenton, MO (US)

Correspondence Address: FOLEY & LARDNER LLP, 321 NORTH CLARK STREET, SUITE 2800, CHICAGO, IL, 60654-5313, US

(73) Assignee: James McHugh Construction Co.

(21) Appl. No.: 12/338,362

(22) Filed: Dec. 18, 2008

Related U.S. Application Data
(60) Provisional application No. 61/008,356, filed on Dec. 20, 2007.

(51) Int. Cl. E04G 21/32; A62B 35/00

(52) U.S. Cl. 182/9

(57) ABSTRACT

A fall-arrest system for securing an individual to a construction site. The system and methods include a first post for insertion into a concrete column. A sleeve connects the first post to a second post that extends above the concrete. A cable is used to connect an individual to the second post, and thus secure them to the construction site. The sleeve prevents lateral movement at the connection of the two posts such that the second post does not rely on uncured portions of the column for support.

### CROSS-REFERENCE TO RELATED PATENT APPLICATION

This application claims priority from U.S. Provisional Patent Application 61/008,356 filed Dec. 20, 2007, herein incorporated by reference in its entirety.

### BACKGROUND OF THE INVENTION

The invention relates generally to the field of fall arrest systems and methods.

One major concern in building multi-story structures is the safety of workers. In particular, the risk of falling becomes a concern. A challenge in providing a system for preventing workers from falling exists because the uppermost floor is being worked on without there being any structure above that level to which the workers can be tethered. Thus, it is necessary to tether the workers back to the current level being worked on or to a preceding level.

However, in order for a worker to be able to be tethered to an existing level, that level must have sufficient structural integrity to support the worker (and the fall arrest apparatus). This presents a problem in modern concrete-based construction. It would be necessary to allow the concrete to cure (harden) prior to tethering a working to the concrete. In particular, this presents a problem for large vertical structures such as sky-scrapers, where an entire floor is likely to be “finished” prior to the concrete having cured sufficiently to support tethering a worker. Thus, it is necessary to delay construction until the concrete has cured sufficiently to support attachment of a fall-arrest system.

### SUMMARY OF THE INVENTION

One embodiment of the invention relates to a fall arrest system. The fall arrest system comprises a pipe and sleeve attached to a concrete structure to provide structurally sufficient tie off points without relying on the strength of the concrete.

In one embodiment, the invention comprises a fall arrest system utilizing a concrete column. The system includes an upright support, the upright support having a plurality of posts and a plurality of sleeves. The plurality of posts are stacked within the concrete column, with one of the plurality of sleeves positioned at a junction between each post and another post. Each of the plurality of sleeves are substantially securing the junction against lateral movement. An upper-most post extends from the concrete column, the upper most post having a safety cable connected at an end distal to the concrete column. The cable is attachable to a user harness and the upright support is able to bear the load of a user attached to the cable in the event of a fall.

In another embodiment, the invention relates to a method of securing an individual to a construction site, comprising disposing a first post in a column of substantially cured concrete. The first post is connected to a second post, which extends beyond the cured concrete, at a junction using a sleeve; the sleeve reinforcing the junction of the first post and second post against lateral movement. A cable is secured to the second post, the cable engagable with a user harness.

In yet another embodiment, the invention relates to a fall-arrest safety device comprising of a plurality of upright supports. The upright supports comprise a sleeve and a post. Each upright support is connected to at least one other upright support via interaction of the sleeve of one upright support with the post of the other upright support, the connection secured against lateral movement. A user tie-off line is engagable with at least one upright support for securing a user to the upright support.

### BRIEF DESCRIPTION OF THE DRAWINGS

FIG. 1 is an illustration of a construction location utilizing the described system;

FIG. 2 illustrates a cut-away view of a fall-arrest system having a sleeve internal to the upright supports;

FIG. 3 illustrates a cut-away view of a fall-arrest system having a sleeve integral to the upright supports;

### DETAILED DESCRIPTION OF THE PREFERRED EMBODIMENTS

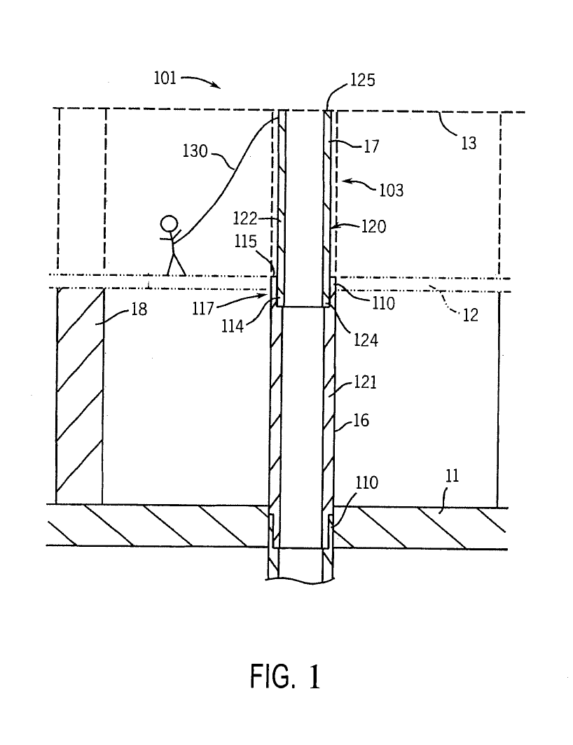

FIG. 1 illustrates a portion of a construction location where a fall arrest system would be utilized. It should be appreciated that a plethora of methods of building a structure may be used, and the following illustration is not meant to be limiting but only to provide an example. FIG. 1 depicts three stories of a construction site, a completed level's floor 11, a current level's floor 12, and the next level's floor 13. The common sequence for construction of the illustrated structure is to place concrete into forms (not shown) on the first day of construction for the current level floor 12. Next, the concrete for columns 16 and walls 18, which will support the next level's floor 13, are poured. The forms for the next level's floor 13 begin to be installed, requiring use of a fall arrest system. For prior art systems requiring tie-off to the concrete columns 16, the concrete columns 16 are not of sufficient strength to support a user's weight until the 4^{th} to 15^{th} day following pouring the concrete.

Typically, on the second day of construction, the installation of the form for the next level's floor 13 is completed, again requiring use of a fall arrest system. Also on the second day, reinforcing steel, conduit, and plumping pipes are installed on the forms. On the third day, the installation of the reinforcing steel, conduit, and plumping pipes is completed. On the fourth day, the concrete floor for the next level's floor 13 is poured and the cycle is started again. For a high rise construction where dozens of floors must be assembled, minimizing the time for this cycle is important.

One embodiment of the invention relates to a fall arrest system 101. The fall arrest system 101 includes at least one upright support 103. The upright supports 103 provide a location for cables, ropes, lines and the like to be attached, providing a secure method for a worker to “tie-back”. The upright supports 103 include at least one sleeve 110 and post 120. In one embodiment, the sleeve 110 and post 120 are integral, with the sleeve 110 being positioned at one end of the post 120, such that the post 120 of another upright support 103 can engage the sleeve 110 to form a connection between the two upright supports 103. In an alternative embodiment, the sleeve 110 and post 120 are separate, but engagable, components such that multiple posts 120 can be connected via sleeves 110 to form a series of connected upright supports 103. In applications where multiple stories are involved, each upright support 103 may comprise a series of sleeves 110 and posts 120 stacked on top of each other to allow the height of the upright support 103 to increase as the construction moves upward with each increasing floor.

Thus, where multiple posts 120 are stacked, lower-positioned posts 121 in the upright support 103 are contained within a column 16 of cured or substantially cured concrete, while the upper-positioned post 122 extends beyond the current level 12. In one embodiment, a first end 114 of the upper most post 122 is substantially disposed within the cured column 16 or floor of the current level 12. The upper-most post 122 may extend through a portion (shown as 17 in FIG. 1) of the column 16 above the current level 12. This column portion 17 may have varying degrees of structure including but not limited to having no structure, a rebar skeleton, or both rebar and uncured concrete. The degree of structure of the column portion 17 may change while the upper-most post 122 is in use, such as through the application of concrete to a rebar skeleton. It should also be appreciated that the upright supports 103 may be used where the portion 17 has been allowed to cure. Thus, the upright supports 103 are retained, at the lower levels, by cured concrete, but the upper most post 122 is retained by its interaction with the other upright supports 103.

The stacking of one post 120 on top of another post 120 will result in a moment being created when lateral force is exerted on the upper-most post 122. In one embodiment, typically used to tie-off a single user, the cord 130 may extend from a user to the post 120. In an alternative embodiment, typically used to tie-off multiple users, a line (not shown) is extended between two posts 120 and the cable 130 is attached to the line. The latter embodiment can also be utilized to provide for greater lateral movement by a user by utilizing a sliding connection between the cable 130 and the line. One type of force that may be exerted on the upper-most post 122 is from the cord 130 connecting the user to the upright support 103. Lateral force (or any force having a lateral component) will result in the upper-most post 122 pivoting about a point such that the upper most post 122 will contact the column portion 17, exerting force on the column portion 17. To prevent this exertion of force on the column portion 17 (which may not be sufficiently cured to bear such a force), the sleeve 110 is utilized to counter the pivoting movement. The sleeve 110 operates to secure the upper-most post 122 to the immediately preceding post 120. In embodiments where the sleeve 110 and post 12 are a singular unit, the upright supports 103 engage with each other, stacking by allowing the end of one upright support 103 to be disposed within the end of another upright support 103. The interconnection of the sleeve 110 and posts 120 operates to resist lateral forces, such as those exerted by the cord 130 when a user falls.

The sleeve 110 and the post 120 are engagable to secure the upright support 103. The post 120 has a first end 124 and a second end 125. The sleeve 110 has a first end 114 and a second end 115. As depicted in the Figures, the first ends 124 and 114 are the “bottom” ends in relation to the ground. In one embodiment, the sleeve 110 and post 120 are engagable such that the second end 115 of the sleeve 110 is at least partially disposable within the first end 124 of the upper-most post 120 and the first end 114 of the sleeve 110 is disposed within the second end 125 of the immediately preceding post 120 in the upright support 103. Thus each post 120 is connected via a sleeve 110 to another post 120. In one embodiment, the sleeves 110 are left in place connecting the posts 120 above and below the sleeve 110 even after the corresponding level is completed and the concrete in the column 16 surrounding the post 120 has cured. In one embodiment, the sleeve length is determined based upon sleeve material; sleeve wall thickness, height of the post, number of users tied off at any given time and the overturning moment on the sleeve/post connection during a fall. In an exemplary embodiment, the sleeve and post diameters are about 4-6 inches. It should be further appreciated that the column need a certain cross sectional area of concrete in order to support the weight above it, as well as its own weight. For example, but without intent to limit, a 24″×24″ column has a cross sectional area of 576 sq in′. A 6″ sleeve removes 28 sq in or about 5% of the area. Thus, in one embodiment, it may be necessary for columns having the upright support 103 to be slightly larger than those without to support the intended design weight. However, it should be appreciated that in many instances, this difference in cross sectional area will be within standard construction tolerances and no modification to the columns will be necessary.

In one embodiment where the sleeve 110 is internal to the post 120, a sleeve retention mechanism 117 is utilized to prevent the sleeve 110 from sliding down into the lower post 121. The sleeve retention mechanism 117 may include, in one embodiment, a protrusion or flange internal to the posts 121 spaced a distance from the second end 125 so as to allow the sleeve 110 to be sufficiently disposed within the post 120. In an alternative embodiment, the sleeve 110 includes a flange that rests on the outer edge 127 of the second end 125 of the post 120, positioned between the upper-most post 122 and the lower post 121, retaining the sleeve 110 in position. In yet another alternative embodiment, the retention mechanism 117 comprises a pin, such as a piece of rebar (not shown), that is inserted into the second end 125 of the post 120, such as through one or more holes (not shown), thus supporting the weight of the upright support 103 against the current level's floor 12 (using rebar as a “pin” to retain/support the post.)

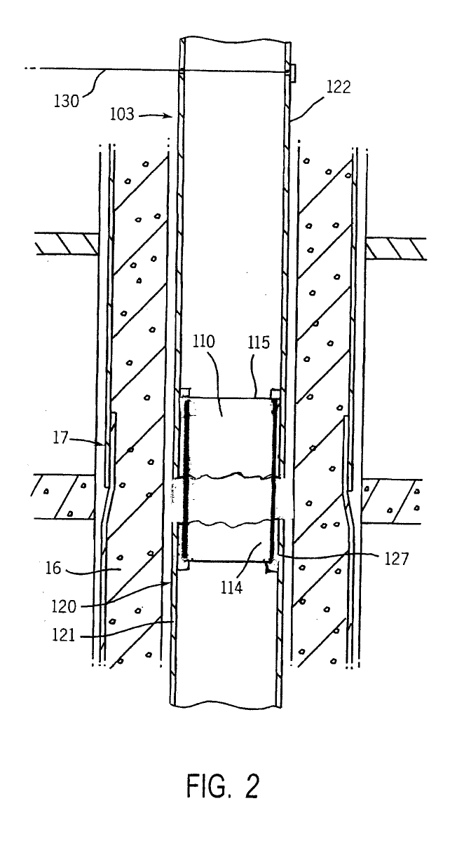

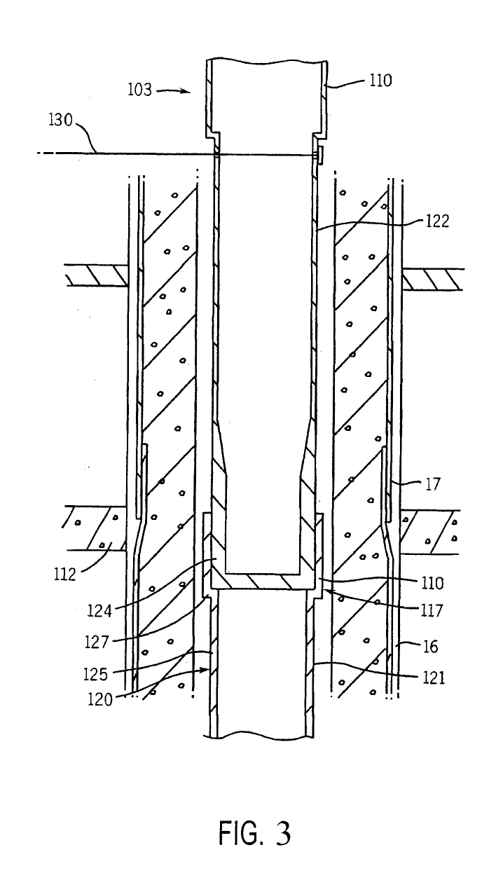

In an alternative embodiment shown in FIG. 3, the sleeve 110 is partially disposable within an end of the post 120. As shown in FIG. 3, the sleeve 110 may be an integral component of the post 120, such that the first end 124 of the post 120 fits into the second end 125 of the preceding post 120. As with the embodiment of the sleeve 110 described above in reference to FIG. 2, the sleeve 110 of FIG. 3 retains the post 120 against lateral movement such as that caused when a user's weight comes to bear against the post via the cable 130.

The sleeve 110 of the upright support 103 may be a separate component or may be an integral part of the post 120 as shown in FIG. 3 or, as FIG. 2 illustrates, the sleeve 110 may be a separate component. It will be appreciated that the interior separate sleeve 110 of FIG. 2 could also be integral to either the first end 124 of the upper-most post 122 or the second end 125 of the lower post 121, with the protruding portion of the sleeve engaging the other post respectively. Likewise, the exterior sleeve 110 of FIG. 3 could be a separate component in accordance with an embodiment of the invention.

While the invention may be utilized with the structures of FIG. 1, it will be appreciated that various embodiments of the invention can be utilized in other applications and situations.

What is claimed is:

1. A fall arrest system comprising:
a concrete column;
an upright support, the upright support having a plurality of posts and a plurality of sleeves;
the plurality of posts stacked within the concrete column, with one of the plurality of sleeves positioned at a junction between each post and another post; each of the plurality of sleeves substantially securing the junction against lateral movement;
an upper-most post extending from the concrete column, the upper most post having a safety cable connected at an end distal the concrete column;
wherein the cable is attachable to a user harness and the upright support is able to bear the load of a user attached to the cable in the event of a fall.

2. A method of securing an individual to a construction site, comprising:
disposing a first post in a column of substantially cured concrete;
connecting the first post to a second post, which extends beyond the cured concrete, at a junction using a sleeve; the sleeve reinforcing the junction of the first post and second post against lateral movement; and
securing a cable to the second column, the cable engagable with a user harness.

3. A fall-arrest safety device comprising:
A plurality of upright supports, the upright supports comprising a sleeve and a post;
Each upright support connected to at least one other upright support via interaction of the sleeve of one upright support with the post of the other upright support, the connection secured against lateral movement; and
A user tie-off line engagable with at least one upright support for securing a user to the upright support.
